(19) United States
(12) Patent Application Publication
(10) Pub. No.: US 2015/0104369 A1
(43) Pub. Date: Apr. 16, 2015

(54) POLYSILICON TRANSPORTATION DEVICE AND A REACTOR SYSTEM AND METHOD OF POLYCRYSTALLINE SILICON PRODUCTION THEREWITH

(71) Applicant: REC Silicon Inc, Moses Lake, WA (US)

(72) Inventor: Robert J. Geertsen, Pasco, WA (US)

(21) Appl. No.: 14/052,559

(22) Filed: Oct. 11, 2013

(51) Int. Cl. C01B 33/027; B01J 8/24

(52) U.S. Cl. CPC C01B 33/027; B01J 8/24
USPC 423/349; 422/139; 137/1

(57) ABSTRACT

A method and system for reduction or mitigation of metal contamination of polycrystalline silicon are disclosed. A conveyance device comprising a flexible synthetic resin tube having an inner surface at least partially coated with an inner layer comprising elastomeric microcellular polyurethane is disclosed for use in fluidized bed reactor operations associated with manufacture and product handling procedures for ultra pure granular polysilicon. Use of the conduit to effect passage of the polysilicon mitigates foreign metal contact contamination from sources otherwise typically present in such manufacturing units.

### FIELD

The present disclosure relates to a polysilicon transportation or conveyance device for inhibiting or mitigating metal-contact contamination of polycrystalline silicon within fluidized bed reactor production and product handling of such ultra high purity granular silicon.

### BACKGROUND

Silicon of ultra high purity is used extensively for applications in the electronic industry and the photovoltaic industry. The purity demanded by industry for these applications is extremely high and frequently materials with only trace amounts of contamination measured at the part per billion levels are deemed acceptable. By rigorous control of the purity of the reactants used to manufacture polycrystalline silicon it is possible to produce such high purity polycrystalline silicon but then extreme care must be taken in any handling, packaging or transportation operations to avoid post contamination. At any time the polycrystalline silicon is in contact with a surface there is a risk of contamination of the polycrystalline silicon with that surface material. If the extent of contamination exceeds certain industrial stipulations then the ability to sell the material into these end applications may be restricted or even denied. In this respect minimizing contact metal contamination is a primary concern if performance criteria in the semi conductor industries are to be attained.

A process for manufacturing polycrystalline silicon that is now gaining in commercial acceptance involves the use of a fluidized bed reactor (FBR) to manufacture granulate polycrystalline silicon by the pyrolysis of a silicon-containing gas in the presence of seed particles. During the use of a fluidized bed reactor system to manufacture the granulate polycrystalline silicon there are a number of transportation steps where granulate polycrystalline silicon, or seed particles, may be moved from the bed of the fluidized reactor to a point external to the reactor chamber, and particularly in the case of granulate polycrystalline silicon when it is desired to harvest the polycrystalline silicon. At all stages of granulate polycrystalline silicon transport there is a risk of contamination by physical contact with the surfaces of the equipment including notably the metal surfaces of the supporting infrastructure of the FBR system, external to the fluidized bed, thereby leading to metal contamination of the granulate polycrystalline silicon. Exemplary of supporting infrastructure are the pipelines and transfer conduits through which granulate polycrystalline silicon must pass. Thus there is an outstanding need to modify supporting infrastructure and mitigate the opportunity of metal contamination from such auxiliary structure and equipment.

### SUMMARY

According to one aspect, a method of reducing or eliminating metal-contact contamination of granular silicon during its conveyance or transportation comprises conveying granular silicon through a synthetic resin tube, having an inner surface at least partially coated with a protective layer comprising microcellular elastomeric polyurethane.

According to a further aspect, a fluidized bed reactor unit for production of granulate polycrystalline silicon comprises a reactor chamber and at least one flexible synthetic resin tube, external to the reactor chamber, having an inner surface at least partially coated with a protective layer comprising microcellular elastomeric polyurethane.

According to a yet further aspect, a process for the production of granular polycrystalline silicon comprises effecting pyrolysis of a silicon-containing gas using a fluidized bed reactor including a feed or discharge conduit comprising a flexible synthetic resin tube having an inner surface at least partially coated with a protective layer comprising a microcellular elastomeric polyurethane; depositing a polycrystalline silicon layer on a seed particle in the fluidized bed reactor to produce granulate polycrystalline silicon, and transporting the seed particle prior to entry, transporting granulate polycrystalline silicon after exit from the fluidized bed reactor, or both via the feed or discharge conduit, which inhibits or eliminates metal contact surface contamination of the seed particle, the granulate polycrystalline silicon, or both, compared to particles transported through a conduit having an inner surface comprising a metal.

Embodiments of the synthetic resin tube having an inner surface comprising a select polyurethane material have sufficient robustness and durability with respect to conveyance of granular polysilicon material to substitute for and replace many previously deployed metal conduits and lined-metal piping typically present in fluidized-bed reactor systems associated with production of ultra high purity granular polysilicon and thereby mitigate and eliminate many sources of metal-contact contamination.

The foregoing and other objects, features, and advantages will become more apparent from the following detailed description.

### BRIEF DESCRIPTION OF THE DRAWINGS

FIG. 1 is a partial cross sectional view showing one example of a flexible synthetic resin tube suited for use in the production of granulate polycrystalline silicon. There is shown a flexible synthetic resin tube including a tube wall (2) made of a plasticized or soft synthetic resin, and a helical reinforcement (3) attached to the outer surface of the tube wall and made of a non-plasticized or hard synthetic resin. The tube wall (2) has a lamella structure comprising a protective layer (4) composed of polyurethane, and in this instance optionally an adhesive intermediate layer (5).

FIG. 2 is a partial cross sectional view showing another example of a flexible synthetic resin tube suited for use in the production of granulate polycrystalline silicon. A flexible synthetic hose (6) includes a protective layer (7) composed of polyurethane, an adhesive intermediate layer (8), and a helical reinforcing core (10) of hard synthetic resin embedded or buried in an outer layer (9) of soft synthetic resin.

FIG. 3 is a schematic diagram of a fluidized bed reactor unit (11) including a reactor chamber (12) and one or more conduits (13A, 13B) comprising a flexible synthetic resin tube having an inner surface that defines a passageway that is in communication with the reactor chamber (12), the inner surface being at least partially coated with a protective layer comprising polyurethane.

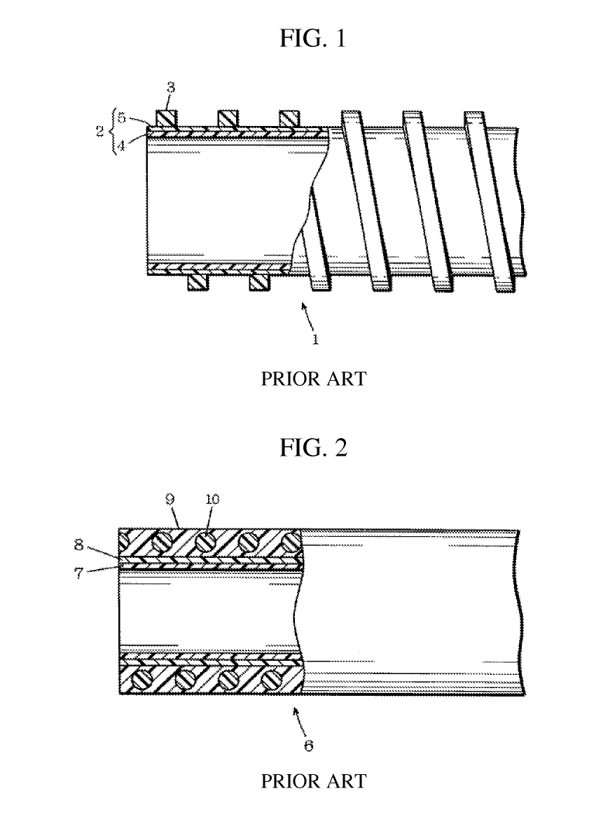

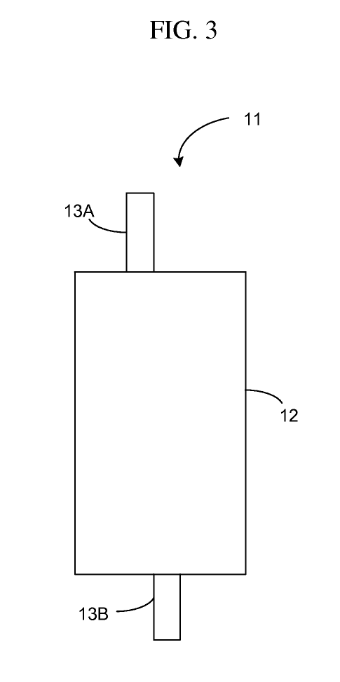

### DETAILED DESCRIPTION

Unless otherwise stated, all numbers and ranges presented in this application are approximate—within the scientific uncertainty values for the tests required to determine such number values and ranges, as known to those of ordinary skill in the art.

This disclosure concerns equipment and processes associated with the manufacturing and transportation of ultra-pure granular polysilicon. A synthetic resin tube, or hose, having an inner surface at least partially coated with a protective layer comprising a microcellular elastomeric polyurethane provides a passage through which polysilicon can be transported or conveyed. For the inner surface, at least 50%, such as at least 75% or 100% of the surface is coated by the protective layer comprising polyurethane. By “protective layer” it is understood a coating layer having an overall average thickness of from at least 0.1, such as from at least 0.3, or from at least 0.5 millimetres; and up to a thickness of about 10, such as up to about 7, or up to about 6 millimetres.

The term “elastomeric” refers to a polymer with elastic properties, e.g., similar to vulcanized natural rubber. Thus, elastomeric polymers can be stretched, but retract to approximately their original length when released.

The term “microcellular” generally refers to a foam structure having pore sizes ranging from 1-100 μm. Microcellular materials typically appear solid on casual appearance with no discernible reticulate structure unless viewed under a high-powered microscope. With respect to elastomeric polyurethanes, the term “microcellular” typically is equated to density, such as an elastomeric polyurethane having a bulk density of at least 600 kg/m³. Polyurethane of lower bulk density typically starts to acquire a reticulate form and is generally less suited for use as protective coating described herein.

Microcellular elastomeric polyurethane suitable for use in the disclosed application is that having a bulk density of from 600 to 1150 kg/m³, and a Shore Hardness of at least 65 A. In one embodiment the elastomeric polyurethane has a Shore Hardness of up to 90 A, such as up to 85 A, and from at least 70 A. Additionally, the suitable elastomeric polyurethane will have a bulk density of from at least 700, such as from at least 800 kg/m³; and up to 1100 kg/m³, such as up to 1050 kg/m³.

Elastomeric polyurethane can be either a thermoset or a thermoplastic polymer; this presently disclosed application is better suited to the use of thermoset polyurethane. Microcellular elastomeric polyurethane having the above physical attributes is observed to be particularly robust and withstands the abrasive environment and exposure to particulate, granulate, polysilicon eminently better than many other materials previously proposed as protective layers for the same application.

Elastomeric polyurethane can be obtained by reaction of a polyisocyanate with a polyether polyol giving a polyether polyol-based polyurethane, or alternatively by reaction of a polyisocyanate with a polyester polyol giving a polyester polyol-based polyurethane. Polyester polyol-based polyurethane elastomers are typically observed as having physical properties better suited to the presently disclosed application compared to the polyether polyol-based polyurethane elastomer and hence are the preferred elastomeric polyurethane for use herein.

The synthetic resin tube, or hose, is preferably a flexible hose or tube. By “flexible” is understood a hose that can be readily and repeatedly coiled, wound, or bent without need for excessive force and without result of permanent deformation. Typically such flexible synthetic resin tube, or hose, has a lamella structure and comprises an inner protective layer mainly formed of the above described microcellular elastomeric polyurethane, an outer layer comprising a soft synthetic resin united with the protective layer, and a reinforcement member at least partially buried in or attached to the outer protective layer. The outer protective layer comprises a soft synthetic resin which can be the same or dissimilar polyurethane, or alternatively a different synthetic resin including a polyamide such as nylon, a polyolefin such as polyethylene, or a poly-vinyl halide such as polytetrafluoroethylene or polyvinyl chloride. By “soft” is meant pliable and/or deformable to a degree without onset of non-reversible change or damage. The soft synthetic resin may be a plasticized resin, i.e., a resin comprising a plasticizer. A plasticizer is an additive that increases the plasticity or fluidity of a material. Exemplary plasticizers include, but are not limited to, phthalates, terephthalates, adipates, sebacates, maleates, polyols, dicarboxylic-tricarboxylic esters, trimellitates, benzoates, sulfonamides, organophosphates, and polyethers. The reinforcement member can be a hard synthetic resin, such as for example a non-plasticized polyvinyl chloride resin, or other material including metal wire or gauze or braid that is present in layers or as a helically wound reinforcement, which serves to reinforce the tube but also to importantly provide for shape retention. By “hard” is meant a relatively rigid material of limited pliability and/or deformity before onset of non-reversible change. The reinforcement member allows the flexible tube to be, if desired, a free standing or minimally supported component within the fluidized bed reactor unit. A polyurethane-lined resin tube including a reinforcement member has advantages over a polyurethane tube in certain situations. For example, the polyurethane-lined, reinforced resin tube may be more desirable in situations where additional support to the installation-infrastructure is needed, which could not be provided by a flexible polyurethane tube.

The flexible synthetic resin tube may have a lamella structure wherein the inner layer comprises elastomeric polyurethane having a Shore Hardness of at least 65 A, preferably from 65 A to 90 A, and a bulk density of from 800 kg/m³; and up to 1100 kg/m³ and more preferably up to 1050 kg/m³; the outer protective layer comprises a soft vinyl chloride resin; the reinforcement member is helically wound reinforcement member that comprises a hard synthetic resin, preferably a non-plasticized polyvinyl chloride resin. The manufacture of flexible synthetic resin tube, or hose, suitable for use in the present invention is described in the literature by publications including U.S. Pat. Nos. 5,918,642; 6,227,249; and 6,024,134, which are incorporated herein by reference. Suitable flexible synthetic resin tube or industrial hose is available commercially from, for example, product distributor Kuriyama of America, Inc and includes products sold under the trademarks Tigerflex® or Ureflex® including notably heavy duty polyurethane-lined material handling hose bearing the product code “UFC200” or “UFC400” understood to be hose having a polyvinyl chloride (PVC) cover with inner polyurethane liner surrounded by a rigid PVC helix.

In one aspect, the disclosed invention relates to a modified fluidized bed reactor unit for production of particulate or granulate polycrystalline silicon wherein the modification comprises use of flexible synthetic resin tubes, or hose, as described above, as feed pipelines or discharge pipelines associated respectively with the feed of particulate polysilicon seed to the reactor, or discharge and harvesting of granulate polysilicon from the reactor. It is known that polyurethane is susceptible to thermal degradation on exposure to elevated temperatures for extended periods of time; thus for the purpose of this disclosed application, the use of a flexible synthetic resin tube having an inner surface constituted by the polyurethane is best limited to regions of the fluidized reactor unit where the operational temperature is 200° C. or less, such as 180° C. or less, or 160° C. or less. The onset temperature for thermal degradation of polyurethane can be controlled to a limited extent by the makeup of the polyurethane polymer but generally temperatures greater than 200° C. will bring about some degree of degradation to the polyurethane polymer. Thermal degradation may compromise the physical integrity of the polyurethane and the hose and potentially lead to carbon contamination of the polysilicon in passage.

The flexible synthetic resin tube can be deployed in the fluidized bed reactor (FBR) unit as a substitute for metal conduit/piping thereby mitigating opportunity for metal-contact contamination. The tube can have vertical to near horizontal placement within the FBR unit and can be as a straight run or helically wound component; the latter configuration is especially of value where it may be desired to retard the travelling velocity of the granulate material without use of a baffle plate or other such like device. The flexibility of the tube facilitates installation and maintenance.

In situations within the FBR unit where the installation of the flexible synthetic resin tube leads to sections where the granulate polysilicon may not be able to sustain a desired travelling velocity under gravity, for example in near horizontal sections, it is possible and in many instances desirable to attach to the external face of the tube a simple vibration device to encourage flow and passage of the granulate material. Use of such devices is facilitated by the general flexibility of the tube and would not be possible in the instances where rigid metal piping or tubing is used for conveyance of the granulate polysilicon material. Particularly suitable vibration devices for use in conjunction with the flexible synthetic resin tube include electromagnetic vibrators or especially pneumatic-mechanical, or roller vibrator devices such as disclosed in patent publication WO 00/50180.

The manufacture of a particulate polycrystalline silicon by a chemical vapour deposition method involving pyrolysis of a silicon-containing substance such as for example silane, disilane, or halosilanes such as trichlorosilane or tetrachlorosilane in a fluidized bed reactor is well known to a person skilled in the art and exemplified by many publications including those listed below and incorporated by reference.

| Title | Publication Number |
|---|---|
| Fluidized Bed Reactor for Production of High Purity Silicon | US2010/0215562 |
| Method and Apparatus for Preparation of Granular Polysilicon | US2010/0068116 |
| High-Pressure Fluidized Bed Reactor for Preparing | US2010/0047136 |
| Granular Polycrystalline Silicon | |
| Method for Continual Preparation of Polycrystalline | US2010/0044342 |
| Silicon using a Fluidized Bed Reactor | |
| Fluidized Bed Reactor Systems and Methods for Reducing | US2009/0324479 |
| The Deposition Of Silicon On Reactor Walls | |
| Process for the Continuous Production of Polycrystalline | US2008/0299291 |
| High-Purity Silicon Granules | |
| Method for Preparing Granular Polycrystalline Silicon | US2009/0004090 |
| Using Fluidized Bed Reactor | |
| Method and Device for Producing Granulated | US2008/0241046 |
| Polycrystalline Silicon in a Fluidized Bed Reactor | |
| Silicon production with a Fluidized Bed Reactor integrated | US2008/0056979 |
| into a Siemens-Type Process | |
| Silicon Spout-Fluidized Bed | US2008/0220166 |
| Method and apparatus for preparing Polysilicon Granules | US2002/0102850 |
| Method and apparatus for preparing Polysilicon Granules | US2002/0086530 |
| Machine for production of granular silicon | US2002/0081250 |
| Radiation-heated fluidized-bed reactor | U.S. Pat. No. 7,029,632 |
| Silicon deposition reactor apparatus | U.S. Pat. No. 5,810,934 |
| Fluidized bed for production of polycrystalline silicon | U.S. Pat. No. 5,139,762 |
| Manufacturing high purity/low chlorine content silicon by | U.S. Pat. No. 5,077,028 |
| feeding chlorosilane into a fluidized bed of silicon particles | |
| Fluid bed process for producing polysilicon | U.S. Pat. No. 4,883,687 |
| Fluidized bed process | U.S. Pat. No. 4,868,013 |
| Polysilicon produced by a fluid bed process | U.S. Pat. No. 4,820,587 |
| Reactor And Process For The Preparation Of Silicon | US 2008/0159942 |
| Ascending differential silicon harvesting means and method | U.S. Pat. No. 4,416,913 |
| Fluidized bed silicon deposition from silane | U.S. Pat. No. 4,314,525 |
| Production of Silicon | U.S. Pat. No. 3,012,861 |
| Silicon Production | U.S. Pat. No. 3,012,862 |

The expression “particulate” or “granulate” refers to polycrystalline silicon that can be seed material brought into the reactor through a feed line or product exiting the reactor via the discharge pipeline and encompasses material having an average size in its largest dimension of from about 0.01 micron, to as large as 15 millimeters. More typically, the majority of the particulate polycrystalline silicon in passage through the feed or notably the discharge pipelines will have an average particle size of from about 0.1 to about 5 millimeters and be essentially spheroid in form and devoid of the presence of any sharp or acute edge structure.

The expression “ultra high purity” refers to polycrystalline silicon which consists essentially of elemental silicon with overall purity of at least 99.9999 wt % (“6N”), such as at least 99.999999 wt % (“8N”) and desirably is essentially free of foreign metal contamination. Any foreign metal, if present, does not exceed a total amount of 1000 parts, does not exceed 150 parts, or does not exceed 100 parts per billion (weight) based on total weight of the granular polysilicon.

It is observed that such flexible synthetic resin tube notably having the above-mentioned polyurethane constitution is able to satisfactorily replace metal pipe and conduit, as used to effect conveyance and transport of the granular polysilicon, in many parts of an FBR unit and thereby eliminate a potential source of metal contact contamination of the granulate polysilicon. The tube is surprisingly robust within the operation unit with minimal failure, has good durability, and provides for very easy maintenance or replacement relative to conventional metal pipe and conduit. Abrasive failure or fractures of the polyurethane lining caused by the transportation of granulate polysilicon at various conveyance speeds is surprisingly low or absent. Carbon contamination of the polysilicon is observed to be minimal and not distracting from the overall purity and quality of the polysilicon.

Although the subject invention has been described with respect to preferred embodiments, those skilled in the art will readily appreciate that changes or modifications thereto may be made without departing from the spirit or scope of the subject invention as defined by the appended claims. In view of the many possible embodiments to which the principles of the disclosed processes may be applied, it should be recognized that the teachings herein are only preferred examples and should not be taken as limiting the scope of the invention.

I claim:

1. A method of reducing or eliminating metal contact contamination of granular silicon during its conveyance or transportation, the method comprising:
conveying granular silicon through a conduit comprising a synthetic resin tube having an inner surface at least partially coated with a protective layer comprising a microcellular elastomeric polyurethane.

2. The method of claim 1 wherein the synthetic resin tube is a flexible tube.

3. The method of claim 1 wherein the microcellular elastomeric polyurethane has a bulk density of at least 800 kg/m³ and a Shore Hardness of at least 65 A.

4. The method of claim 3 wherein the microcellular elastomeric polyurethane has a Shore Hardness of from 65 A to 85 A and a bulk density of from 800 to 1150 kg/m³.

5. The method of claim 1 wherein the protective layer has an average thickness of at least 0.1 millimetres and up to 10 millimetres.

6. The method of claim 2 wherein the flexible tube further comprises an outer layer comprising a soft synthetic resin united with the protective layer, and a reinforcement member buried in or attached to the outer layer.

7. The method of claim 6 wherein the microcellular elastomeric polyurethane of the protective layer has a Shore Hardness of at least 65 A, the outer protective layer comprises a soft vinyl chloride resin, and the reinforcement member is a helically wound reinforcement member that comprises a hard synthetic resin.

8. The method of claim 1 wherein the synthetic resin tube is a component associated with a fluidized bed reactor installation for granular polysilicon production, but excluding a fluidized reactor bed chamber of the fluidized bed reactor installation.

9. A fluidized bed reactor unit for production of polycrystalline silicon, comprising:
a vessel defining a reactor chamber; and
at least one flexible synthetic resin tube, external to the reactor chamber, having an inner surface that defines a passageway that is in communication with the reactor chamber, the inner surface being at least partially coated with a protective layer comprising a microcellular elastomeric polyurethane.

10. The fluidized bed reactor unit of claim 9 wherein the microcellular elastomeric polyurethane has a bulk density of at least 800 kg/m³ and a Shore Hardness of at least 65 A.

11. The fluidized bed reactor unit of claim 10 wherein the protective layer has an average thickness of at least 0.1 millimetres and up to 10 millimetres.

12. The fluidized bed reactor unit of claim 9 wherein the flexible tube further comprises an outer layer comprising a soft synthetic resin united with the protective layer, and a reinforcement member buried in or attached to the outer layer.

13. The method of claim 12 wherein the microcellular elastomeric polyurethane of the protective layer has a Shore Hardness of at least 65 A, the outer layer comprises a soft vinyl chloride resin, and the reinforcement member is a helically wound reinforcement member that comprises a hard synthetic resin.

14. A process for the production of granular polycrystalline silicon, comprising:
effecting pyrolysis of a silicon-containing gas using a fluidized bed reactor comprising a feed or discharge conduit comprising a flexible synthetic resin tube having an inner surface at least partially coated with a protective layer comprising a microcellular elastomeric polyurethane;
depositing a polycrystalline silicon layer on a seed particle in the fluidized bed reactor to produce granulate polycrystalline silicon; and
transporting the seed particle prior to entry, transporting granulate polycrystalline silicon after exit from the fluidized bed reactor, or both via the feed or discharge conduit in which the flexible tube inhibits or eliminates metal contact surface contamination of the seed particle, the polycrystalline silicon particle, or both.

15. The process of claim 14 wherein the microcellular elastomeric polyurethane has a bulk density of at least 800 kg/m³ and a Shore Hardness of at least 65 A.

16. The process of claim 14 wherein the flexible tube further comprises an outer layer comprising a soft synthetic resin united with the protective layer, and a reinforcement member buried in or attached to the outer layer.

17. The process of claim 16 wherein the microcellular elastomeric polyurethane of the protective layer has a Shore Hardness of at least 65 A, the outer protective layer comprises a soft vinyl chloride resin, and the reinforcement member is a helically wound reinforcement member that comprises a hard synthetic resin.
